(19) United States
(12) Patent Application Publication
(10) Pub. No.: US 2015/0127445 A1
(43) Pub. Date: May 7, 2015

(54) Customer Loyalty System and Method

(71) Applicant: Andrew I. Jaffee, Monson, MA (US)

(72) Inventor: Andrew I. Jaffee, Monson, MA (US)

(21) Appl. No.: 14/535,402

(22) Filed: Nov. 7, 2014

Related U.S. Application Data
(60) Provisional application No. 61/901,375, filed on Nov. 7, 2013.

(51) Int. Cl. G06Q 30/02

(52) U.S. Cl. CPC G06Q 30/0226; G06Q 30/0224
USPC 705/14.25

(57) ABSTRACT

A loyalty system and a method for customer retention that enables users with mobile devices to interface with venues through a loyalty system using a single application. The application is fully customizable based on the preferences of the venue and the customer and may display different information depending on the venue, location of the user, day, or time at which the customer is present at a venue. The customer interacts with the venue through the loyalty system and may set criteria for rewards and promotions. The loyalty system allows end users to participate in real-time events, receive relevant entertainment information, and receive rewards for participation. Venues may reward end users for participation and target incentives based on preferences of the venue which may be determined by the information collected or according to a schedule.

### BACKGROUND

The disclosure relates to a customer loyalty system and method for enhancing customer experiences, delivering customer incentives, and enhancing revenue for host venues.

At sports bars, restaurants, and other venues, guests may spend more time looking at their mobile devices than socializing with their friends and enjoying the venue's atmosphere. Customer engagement with mobile devices presents a customer engagement opportunity for venue operators. Mobile devices are typically connected to the internet and likely include the ability to connect to a local WiFi signal that may be present in the venue.

Venue operators need tools to bring in new customers, enhance the experience of customers who are already at the venue and to enhance revenue per customer. Standard loyalty programs and marketing tactics typically fail to differentiate a venue from its competitors. As reflected in the entertainment, restaurant, and hospitality sector's early adoption of flat-panel HD televisions, the industry will adopt innovative technology to deliver unique guest experiences.

A growing number of national and local restaurants offer their own mobile app; however, these apps seldom provide a compelling experience to motivate a significant number of downloads. Many restaurant apps suffer from poor customer reviews based on a failure to provide innovative guest features or experiences. In addition, consumers are not prone to download an individual app for each restaurant they frequent.

Current mobile loyalty platforms are little more than digital representations of the standard punch card. Businesses require a more innovative solution in today's era of check-ins, scans, and digital punches. Since many venues lack a standard point-of-sale area, solutions that require a mobile action at the point of sale may not be feasible. In addition, longer customer dwell times at many venues present an opportunity to provide a more comprehensive loyalty solution.

### SUMMARY

The disclosed system is an entertainment and loyalty platform that enables venues to engage their customers through interactive, social experiences. The disclosed system includes a web-based content management system (CMS) with data collection capability, a mobile app, and HTML5-content that can be delivered to multiple displays, including in-venue flat panels and customer mobile devices. The HTML5-content includes sports and music-themed games, sweepstakes, trivia, and social experiences which reward participation and customer loyalty with venue-specific prizes.

The web-based CMS enables managers at subscribing venues to customize the customer (who may also be referred to as an “end user”) experience by selecting from the available content, scheduling unique guest experiences, and setting rewards based on the venue's participation preferences. The CMS affords the ability for venue owners to designate loyalty program rewards at a national, regional, and individual location level. Allowing each venue to create an individualized customer experience provides maximum flexibility and should permit a wide range of venues to create successful loyalty programs to suit their clientele and regional/local preferences.

A mobile app is provided to customers for free. The same app gives access to all participating venues, but the customer experience with the app at each venue can be unique, since the venue can customize the content and rewards. The app collects basic information from a user to establish a unique identifier recognized by the web-based CMS. End user participation is “permission based”, meaning that the end user has control over the information they provide, and the extent to which they will receive promotions from participating venues. Some customer information, such as location, favorite sports team, and the like can be used to filter content to create a customized end user experience with the app. For example, if a user designates their favorite sports team as the Pittsburgh Steelers, then the app may deliver scores for that team or football themed content. Appropriate venues may push notices to this user for football game times and special offers as an incentive for the user to view that game at the venue.

Content available on the app will include HTML5-based interactive games and activities (collectively “experiences”) that encourage customer interaction with other customers and content displayed on displays at the venue. Venues select from the available games and activities and choose customer actions that result in points toward incentives or rewards. Venues have control over the number of points necessary to redeem rewards and the app will display available rewards to customers who have checked in at the venue. Rewards for which the customer has sufficient points are available to be redeemed. Rewards requiring more points are not shown as available until sufficient points are earned.

The mobile app is available in the primary mobile operating systems, iOS (Apple) and Android (Google). Compatibility with other mobile operating systems is contemplated. The mobile app includes tabs for a user's Profile, Experiences, and Rewards. The Experiences tab shows games and interactive activities available at the user's location. Each experience or activity is built on a web-based architecture, meaning the content resides on the centralized web-based CMS and does not reside in the mobile device. This framework allows for efficient development across mobile platforms, while making integration with third-party content seamless. Additions or content updates are made at the web-based CMS, reducing the need for users to update system content. The Rewards section of the mobile app allows a user to view the points he's earned across venues, each location's Rewards Wall, and the redeemable vouchers within his prize vault.

A diverse range of mobile engagements that incorporate fantasy sports, trivia, music, social gaming, and sweepstakes are stored on the web-based CMS for delivery to end users and venues. Experiences can be mobile-only (MO), incorporate phone-to-screen engagement (PS), facilitate phone-to-phone interaction (PP) or offer a mix of the three. Every experience may allow the user to earn loyalty points while also giving users full social sharing capabilities. Examples of games and interactive activities include:

Fandemonium™ (MO)—Sports schedules meet social sharing. Ever wonder what games are on TV at your favorite sports bar? Fandemonium not only tells you, it also reminds you when your favorite teams and sports are playing. Fans can view their favorite team's schedule, while sharing to their social networks where they are watching the game.

Game Picks™ (MO)—A progressive game that challenges guests to pick the winners of sports action across every professional and collegiate league. The location is the playing field in this pick ‘em game. Pick game winners daily to win great prizes as determined by venue operators.

Whose Round™ (MO, PP)—A social experience that links friends’ phones to decide who is buying the next round. Phones blink randomly as the game chooses who buys next.

Random Rewards™ (Mo, PP)—Guests enter a live sweepstakes with their smartphone and watch the digital dice roll as a lucky winner is selected.

P.O.V.™ (PS)—Guests respond to live poll questions, and the results are displayed on a venue's TVs. Makes polls live and interactive. Guests voice their opinion via their mobile device.

PicPost™ (PS)—Connecting people's pictures and social profile photos with check-ins. What better way to say, “I'm Here,” than with a picture?

Sweeps™ (PP, PS)—A mobile-enabled prize giveaway mixed with social media content. Guests who enter the contest have their photos broadcast on in-venue screens. Sweeps randomly chooses a single winner to receive a prize which is sent directly to his phone.

iJukebox (MO, PS)—Guests DJ a location's music with their mobile device. Guests select and vote on songs to decide a venue's music.

TriviaScape (MO, PS)—A daily trivia game that combines videos, images, sports highlights, and YouTube clips to test your knowledge across a variety of topics.

Social Wall™ (PS)—The intersection of sports and social media. Professionally curated content from Facebook, Twitter, Instagram, and Foursquare that delivers a new kind of fan viewing experience. Social content from athletes, sports teams, broadcasters, and professional leagues, connecting fans to media that matters.

Squares (MO)—A game that we all play during the Super Bowl is now available at your favorite places. Claim a square. If your numbers match the score at the end of each quarter, you're a winner.

Fantasy Feud™ (MO)—A game that challenges guests to draft daily fantasy teams across all major sports.

The web-based platform aggregates content and interactive mobile experiences to provide guests with the optimal experience for their current location. In delivering custom games in conjunction with titles developed by third-party publishers, the disclosed system ensures that its overall offering satisfies a range of business needs. Subscribing venues can customize the content and rewards for each location, allowing participating venues to stand out from other subscribing venues with distinct offerings compatible with their location and atmosphere. The content may also be changed by the venue according to the date or time at which the user accesses the application. This allows the venues to promote special events and increase customer interest and customer retention. Users may customize the extent of their participation in advertising and marketing from participating venues to enhance customer satisfaction, making customers more likely to participate in the loyalty programs. Delivering customer information to participating venues according to preferences facilitates targeted advertising and promotional activity.

Third party content providers, such as game developers, can create content for delivery from the web-based CMS. The disclosed system is “open” meaning that it employs web-standard non-proprietary components and languages, such as HTML5, making it easy for third parties to provide content. Content providers may be compensated by sharing in subscription and/or advertising revenue associated with content they provide. This allows for unique content to be delivered through the web-based CMS, without development cost to the system or venue; the new content essentially pays for itself.

Third-party publishers develop mobile and screen-based experiences that can be promoted to venue subscribers. Participating venues then subscribe to such third-party content at an incremental cost. Subscription revenue generated from games or activities created by third-party publishers can be shared with content creators. For example, the creator may earn 70% of monthly revenue attributable to their content while the remaining 30% is available as a revenue stream to the disclosed system. The disclosed system incorporates application program interfaces (APIs) to allow third-party publishers to interoperate with the system-supported phone-to-screen interactivity, social functions, loyalty and rewards capabilities, as well as the system push notification system.

The disclosed system functions in part as a content aggregator, utilizing features of mobile devices (such as touch screens) in parallel with Internet-enabled digital screen media. Venues may choose to supplement their offering with digital signage that is interactive with various system-delivered games or activities. One example is a trivia game where questions are presented on venue mounted flat panel displays, while customers participate via their mobile devices. Digital signage presents system and venue operators with the opportunity to deliver advertising or promotional content along with entertainment, games and activities. This presents a potential additional revenue stream.

Next-generation digital media and content can be delivered as OTT (over-the-top) programming into commercial hospitality venues via the disclosed web-based CMS platform. This includes social content (Instagram, Twitter, Facebook, and Vine), streaming media, premium Web content, news and data feeds, interactive experiences, and advertising. By incorporating a venue's existing displays into a 360-degree guest experience, each pillar of the disclosed system strengthens the other. On-screen content, such as social media walls, phone-to-screen games and real-time leaderboards, are designed to motivate greater use of the mobile app.

Guests interacting with the mobile app are encouraged to also interact with in-venue screens. This expands the reach of their game play and pushes their social interactions outward to the entire venue. Experience leaderboards presented on-screen, which also highlight the rewards available to customers, are designed to motivate app downloads and app re-engagement. Customers not already using the mobile app will want to get in on the fun.

Venues with existing Internet-enabled media delivery systems can take advantage of the company's pre-existing screen media products. This includes PicPost, POV, Sweeps, and the social media wall described above. Restaurants that have customer-facing digital signage networks can easily add the disclosed HTML5-based screen media content to their playlists. As all system screen experiences reside in the web browser and are delivered in internet standard open formats, display does not require any proprietary software or plugins. Any internet-connected media system can play content according to the disclosed system.

The web-based CMS enables the delivery of customizable playlists, media, and experiences on a national, regional, or local level. The subscriber-customizable loyalty platform gives venue managers the ability to specify rewards and prizes on an experience-by-experience or a national level. The disclosed system has a tenant structure that offers permissions-based control of a chain's loyalty program.

Loyalty points are delivered according to criteria based upon guest participation and achievement. Subscribing venues have the ability to designate point schedules across all experiences. In addition to incremental loyalty points, prizes can be distributed through the platform to a customer. A prize voucher for participation or achievement in a given experience can be sent directly to a user's smartphone. Prizes may include venue specific logos and information, further enhancing the venue visibility with existing and potential customers.

Functionality within the web-based CMS allows each venue to create a Rewards Wall for point redemption. A venue's Rewards Wall designates specific prizes and the points required to redeem them. Once a guest has earned loyalty points at a participating venue, that establishment's Rewards Wall becomes visible within the mobile app. This gives a user the opportunity to claim rewards up to his current loyalty point threshold, as well as view locked rewards that require additional points. In showcasing rewards available at higher point totals, the strategy increases the aspirational value of each prize.

The mobile app includes a user messaging system to drive app engagement and retention. Users may choose to receive push notifications from the mobile app that alert them to experience performance, special promotions, rewards, and social mentions. Push notifications function as a powerful means to communicate with customers, thereby creating enormous value for subscribing venues. Customers can limit their participation in notices by making selections, which may enhance their satisfaction with the loyalty program. Such customer control may broaden participation.

The web-based CMS includes functionality to customize push messaging at a venue and experience/game/activity level. This affords experience publishers the ability to deliver custom messages to encourage continuous game play. The push messaging system has geo-location capabilities, targeting users with notifications when they are most likely to engage with the mobile app. For example when users are within a predetermined distance of a subscribing venue.

The disclosed platform makes strategic use of email marketing to influence user behavior. Email campaigns can be created within the system to inform users of special promotions, loyalty point accrual, expiring rewards, and bonus opportunities for app re-engagement. System emails can be co-opted by regional and national restaurant chains. Custom targeted rewards can be used to motivate guests to return to participating venues.

Delivering customer insights and analytics is one feature of the disclosed customer loyalty systems and methods. The disclosed web-based CMS includes a reporting module. System reporting analyzes user interactions, engagement, and overall behavior. This data gives subscribing venues the ability to quantify the ongoing performance of their loyalty programs.

The data analytics package offers both a current snapshot, as well as an overall trend analysis of user behavior and program performance. The data collected measures information at important points along the customer participation timeline: from initial app download to re-engagement and social media impact. The breadth of data available through the reporting system delivers continuous value to participating venues and permits venues to adjust their offerings to maximize desired outcomes.

Subscribing venue operators can view the following data:
Total Users
Total Interactions
Interactions per Experience
Duration of Engagement
Social Sharing
Total Points Earned
Rewards Delivered
Rewards Redeemed
User Demographics (age, sex, location)

The disclosed system is a managed, but highly customizable solution that employs mobile devices already in the possession of a majority of venue customers. The disclosed system turns guests' mobile devices from distractions into allies for venues to use to better engage and communicate with their customers. The disclosed system employs geo-location, intelligent push notifications, social interactivity, and a customizable loyalty system to make a customer's time in a venue more enjoyable and entertaining.

Revenue is generated by charging a monthly subscription fee to subscribing venues. Additional revenue streams may include the sale of advertising on in-venue screens and mobile apps. Developing customized games for network sponsors and chain subscribers presents another possible revenue stream.

### BRIEF DESCRIPTION OF THE DRAWINGS

The following illustrations assume those skilled in the art will understand that the disclosed systems and methods are practiced on modern digital computers and/or web-servers, each of which includes at least one processor, memory, a user interface/display, and communication capability (both local and via the internet). The structure and functionality of mobile devices is well-known to include processors, memory, a display that may be a touch screen, a keyboard which may be a virtual keyboard on a touch screen display and communication capability via local WiFi signal and/or cell phone communication systems.

FIG. 1 is a simplified block diagram showing the basic participants and components of the disclosed loyalty system; and

FIG. 2 is a flow chart illustrating participants in the disclosed loyalty system and selected participant actions and relationships.

### DETAILED DESCRIPTION OF THE DISCLOSED EMBODIMENTS

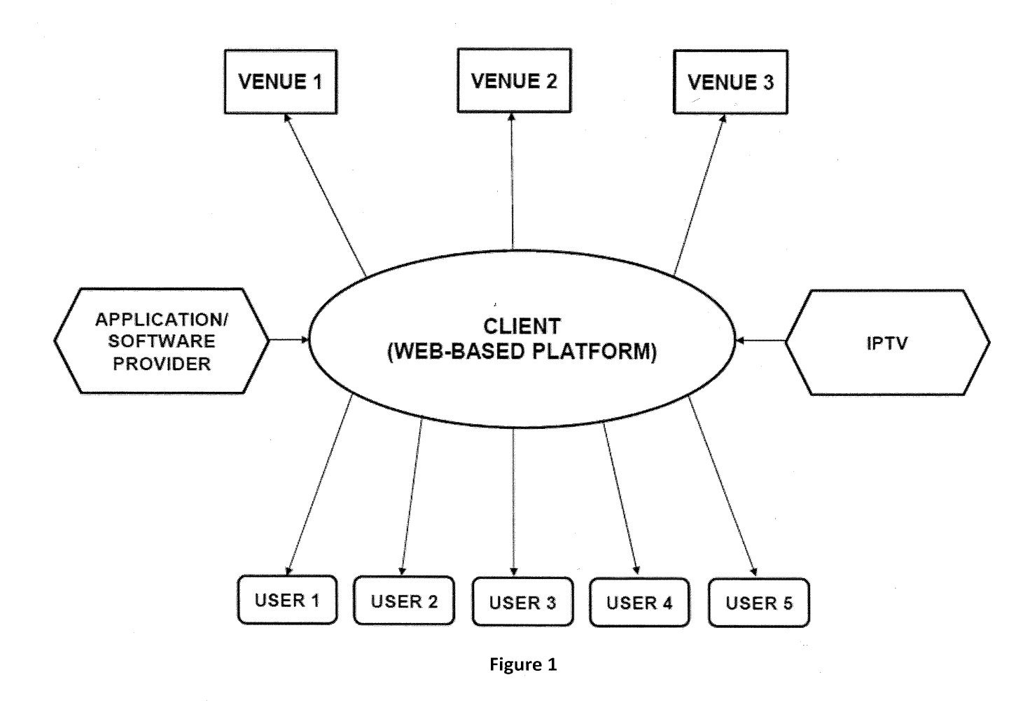

With reference to FIG. 1, the disclosed loyalty system includes a web-based CMS platform, which is connected via the internet to subscribing venues and participating end users, who may be customers of one or more of the subscribing venues. End users will typically interact with the loyalty system via their mobile device, e.g., phone or tablet, but the disclosed system is compatible with venue-provided equipment as well. Content on the web-based CMS includes core offerings provided by the loyalty system operator, third party created games and activities and internet protocol television (IPTV) and/or video. Each venue and end user is uniquely identified to the web-based CMS and is delivered content according to the venue's preferences and selections made by the end user.

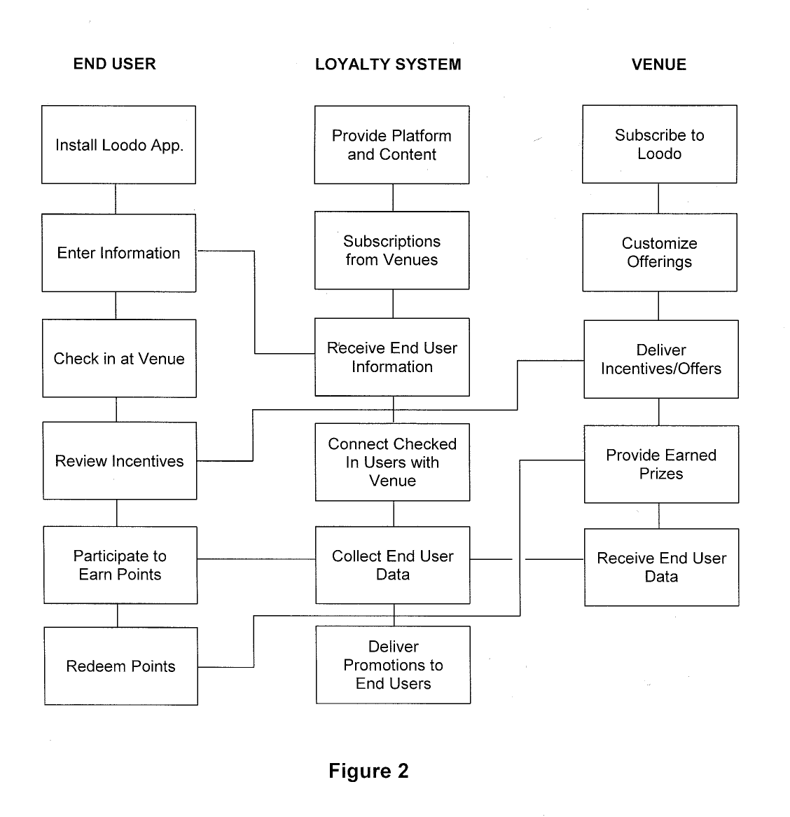

With reference to FIG. 2, the disclosed loyalty system and methods provide unique opportunities for each of the participants. The loyalty system operator provides the web-based platform and a core content offering. The core content offering may be supplemented by third party software/games/activities and/or third party IPTV and video. IPTV and video content might include local school sports events or other content of interest to customers at a particular venue. The web-based platform includes modules for email marketing, push notifications to mobile devices, data acquisition and analytics, in addition to content delivery to multiple screens via the internet and/or mobile phone networks. The web-based platform may be customized depending on the date or time according to preferences. Subscribing venues pay a monthly fee to participate, which entitles them to the core content, email and push marketing, as well as data and analytics collected by the system. Venues may subscribe to third party content according to the revenue sharing model described above.

Venues subscribe to the loyalty system and are able to select from the available core and third party content, with their subscription fee calculated accordingly. Venues may customize their rewards program as well, setting criteria to dictate what levels of customer participation will result in rewards points and independently creating rewards and assigning point values needed to redeem rewards. The loyalty system delivers the customized content and rewards to participating end users. Venues also have access to the email and push notification modules. Venues have at least three channels for communication with participating end users: email, push notifications and in-venue displays. Venues also benefit from receiving information regarding participating end users such as mailing addresses, age, sex, location, etc. for use in crafting their incentive programs. Data regarding end users allows venues to track the effectiveness of the loyalty program and make adjustments or test new incentives.

Each end user installs the mobile app, which gives access to all subscribing venues' selected content and incentives. The mobile app requests permission to employ the user's location to target marketing from participating venues. The end user may make selections to opt in or out of participation in email and/or push notification marketing, giving a desirable measure of control over participation in the program. The end user enters basic identifying information, including a user-ID and password, so each end user is uniquely identified to the loyalty system for data collection and analytics purposes. An end user will typically check in upon arrival at a subscribing venue, which initiates interaction between customer's mobile app, the venue and other customers in the venue that have activated the mobile app. As described above, the customer can then review what incentives the venue has chosen and see what kinds of games/activities will generate loyalty points toward those incentives. When the end user/customer has accumulated sufficient points to redeem an incentive according to the venue established criteria, then the customer redeems the incentive in the mobile app, which redemption is delivered to the venue. The venue in turn prepares and delivers the selected incentive to the customer.

In most instances, the web-based CMS platform is the interface between end users and participating venues. Information passing through the web-based CMS platform is retained according to end user selections. This information and participation data may be used to enhance the effectiveness of venue loyalty programs.

The disclosed loyalty systems and methods provide incentives for each participant that encourages use of the system. Customers enjoy an enhanced experience at the venue, while having the opportunity to earn rewards. Venues have multiple, permission-based channels of communication with customers, as well as information and data to employ in refining the design of their rewards programs. The information and data available through the disclosed systems and methods are an added benefit that might not otherwise be available.

1. A customer retention system, comprising:
an application installed on a mobile device associated with an end user, said application configured to collect information relating to the end user, depict interactive content on a display of the mobile device, record selections inputted by the end user, and connect to one or more networks capable of determining a device location corresponding to a geographical location of the device;
a loyalty system in communication with said application, said loyalty system configured to store an aggregate of said interactive content, deliver a subset of said interactive content to said application, and receive and store said information relating to the end user and said selections made by the end user; and
a venue having a venue location, a set of preferences, and a local network in communication with said loyalty system and said application; said preferences designate said subset of said interactive content said loyalty system sends to said application and determine which rewards and promotions said loyalty system sends to said application based on criteria set by the venue; said local network stores said preferences, receives said information relating to the end user and said selections inputted by the end user, and sends said rewards and promotions to the end user based on said criteria;
wherein the end user interacts with said application to participate in said interactive content individually or as part of a group of end users, reviews incentives for said participation, and receives rewards and promotions through said application based on said criteria.

2. A customer retention system of claim 1, wherein said preferences change based on a schedule.

3. A customer retention system of claim 1, wherein said criteria change based on a schedule.

4. A customer retention system of claim 1, wherein said preferences change based on said information relating to the end user.

5. A customer retention system of claim 1, wherein said criteria change based on said information relating to the end user.

6. A customer retention system of claim 1, wherein said preferences change based on said selections made by the end user.

7. A customer retention system of claim 1, wherein said criteria change based on said selections made by the end user.

8. A customer retention system of claim 1, wherein the end user checks in at said venue when said device location is within a predetermined distance of said venue location.

9. A customer retention system of claim 1, wherein the venue further comprises a display that depicts additional interactive content.

10. A method for customer retention, comprising:
installing an application on a mobile device associated with an end user;
connecting said application to one or more networks capable of determining a device location corresponding to a geographical location of the device;
collecting information relating to the end user with said application;
storing an aggregate of interactive content on a loyalty system;
designating a subset of interactive content with a local network according to preferences set by a venue;
connecting said application to said loyalty system supplied by the venue having a venue location through said local network;
displaying interactive content on a display of the mobile device based on said preferences set by the venue;
recording selections inputted by the end user in said application with said loyalty system;
sending said information relating to the end user and said selections inputted by the end user to said local network; and
providing incentives for further participation and rewards to the end user based on criteria set by the venue.

11. A method for customer retention of claim 10, wherein said preferences change based on a schedule.

12. A method for customer retention of claim 10, wherein said criteria change based on a schedule.

13. A method for customer retention of claim 10, wherein said preferences change based on said information relating to the end user.

14. A method for customer retention of claim 10, wherein said criteria change based on said information relating to the end user.

15. A method for customer retention of claim 10, wherein said preferences change based on said selections made by the end user.

16. A method for customer retention of claim 10, wherein said criteria change based on said selections made by the end user.

17. A method for customer retention of claim 10, further comprising:
determining the presence of an end user within a predetermined distance of said venue location; and
prompting the end user to check in at said venue when said device location is within a certain distance of said venue location.

18. A method for customer retention of claim 10, further comprising:
displaying additional interactive content on a display located in the venue.
